(19) United States
(12) Patent Application Publication
(10) Pub. No.: US 2011/0188567 A1
(43) Pub. Date: Aug. 4, 2011

(54) SYSTEM AND METHOD FOR ADAPTIVE RATE SHIFTING OF VIDEO/AUDIO STREAMING

(76) Inventor: David Frederic Blum, Strasbourg (FR)

(21) Appl. No.: 12/734,638

(22) PCT Filed: Nov. 13, 2008
(86) PCT No.: PCT/IL08/01499

§ 371 Date: Feb. 4, 2011

Related U.S. Application Data
(60) Provisional application No. 60/996,381, filed on Nov. 14, 2007.

(51) Int. Cl. H04N 7/26

(52) U.S. Cl. 375/240.02; 375/E07.154

(57) ABSTRACT

The present invention discloses a method for carrying out video and/or audio adaptive-rate streaming, comprising providing two or more encoders, wherein each encoder is tuned to and responsible for a specific range of bandwidth, and a media bridge forwarding data packets from an encoder to one or more clients, wherein the encoder is selected according to statistics representing one or more communication quality parameter.

### FIELD OF THE INVENTION

This invention relates to video and/or audio streaming and more particularly to a system allowing adaptive rate shifting.

### BACKGROUND OF THE INVENTION

Many open research problems deal with in video and/or audio streaming and are related to compression, network design, network transport, error correction, error concealment, and caching.

Current video and/or audio streaming systems suffer from occasional short-lived faults such as temporary loss of video and/or audio signals and/or artifacts arising due to network congestions and/or transmission errors. These problems generate video and/or audio streams which cannot be readable and/or viewable and/or listenable. Nevertheless, Streaming allows live access to video or/and audio resources having a lower quality as compared with the same content obtained from a classically downloaded file.

The so-called “Progressive Download” technology allows to download a media file and to visualize and/or listen to it with a better quality than streaming. However “Progressive Download” is not as powerful and as flexible as streaming, because it suffers from limitations, such as it cannot be used for casting live events, it cannot be automatically adjusted to the available bandwidth of the end user's connection, and it is less secure because video and/or audio files are saved on the end-user's computer. Technically, when a Progressive Download process is initiated, media file download begins, and the media player waits to begin playing the complete download of said file. Waiting times before playing the downloaded file can be extremely variable (a few minutes to a few days) depending on networks conditions. Therefore, Progressive Download is not a fully acceptable solution to overcome the problem of media distribution and its presentation over a network.

WO/2005/109224 describes Simulcoding techniques and Adaptative Streaming. Simulcoding is a protocol dividing large video files into many small files called “streamlets”, in WO/2005/109224. Each “streamlet” is a video segment of a predefined short time. Servers process each “streamlet” and apply the publisher-determined parameters (bit rate, frame size, frame rate, codec type, constant or variable bit rate, 1-pass or 2-pass encoding, etc.), bit rate by bit rate. There are many versions of each “streamlet”, each version with a different bit rate. Encoded “streamlets” are stored on standard HTTP Web servers, in contrast to what most streaming providers do, which store video files on media servers).

The Simulcoding approach can be used in “Adaptive Streaming”. As an example, when an Internet user requests a video, by using a standard HTTP “GET” request, “streamlets” are transferred over a network from a server to a client browser or client application where they are reassembled in the correct initial order. The delivery protocol uses multiple TCP sessions to improve the reliability of the transmission and increase the total carrying capacity during each unit of time.

WO/2005/109224 discloses a characteristic of the Adaptive Streaming, i.e., the ability to adapt to the available bandwidth of each client connection anytime during streaming. “Adaptive Streaming” can avoid buffering by adjusting image quality to fit with the available bandwidth of a client connection. This is achieved according to a set of “streamlets” for each bit rate specified in the profile of the publisher. Since the client protocol needs to upshift or downshift the bit rate, the correct time-indexed “streamlet” from the appropriate bit rate set is retrieved from the server. Therefore, the media player can easily interchange bit rates by retrieving the appropriate time-indexed streamlet from the desired bit rate pool. Thus, bit rate can change quickly and seamlessly as network conditions fluctuate and because each “streamlet” is a small segment of video, seeking and starting can happen quickly (within the time length of one individual streamlet).

It is an object of the present invention to overcome the limitations of Simulcoding.

It is another object of the present invention to overcome the limitations of Adaptive Streaming.

It is a further object of the present invention to provide a method allowing to split the available bandwidth to sub-bandwidth.

Further purposes and advantages of this invention will appear as the description proceeds.

### SUMMARY OF THE INVENTION

The method for carrying out video and/or audio adaptive-rate streaming according to the invention comprises providing two or more encoders, wherein each encoder is tuned to and responsible for a specific range of bandwidth, and a media bridge forwarding data packets from an encoder to one or more clients, wherein the encoder is selected according to statistics representing one or more communication quality parameter. According to one embodiment the statistics are a combination of blockiness level (as hereinafter defined) and packet loss level.

According to another embodiment of the invention the statistics are a combination of a value of a parameter relating to visual quality, and a value relating to the level of quality of a channel.

In an embodiment of the invention a media bridge switches users continuously to an encoder according to client statistics computed and send by client to the media bridge. Said media bridge controller module may decide from which encoder to send packets and to which client to forward said packets. The packet may comprise, for instance, a group of pictures. In another embodiment of the invention the media bridge controller is configured to generate an average performance factor for each encoder according to statistics received from users connected to said encoder.

The invention is also directed to a system for the video and audio adaptive-rate streaming, comprising a plurality of encoders, each of which is tuned to and responsible for a specific range of bandwidth, each encoder being suitable to adapt the bit rate in its bandwidth range by averaging feedback of clients and to stream continuously to a media bridge as a Group of Pictures resolution.

In one embodiment of the invention the lowest encoder group has the lowest quality and the highest encoder group has the highest quality. In another embodiment of the invention the media bridge module is configured to take Group of Pictures from each encoder and to forward said Group of Pictures to users.

In yet another embodiment of the invention the media bridge controller is configured to connect any new user to a specific encoder depending on feedback statistics sent by the client to the media bridge controller using the Group of Pictures resolution. The media bridge can be configured to check that the statistics sent by the client match its encoder and are suitable to update it.

The media bridge, among other things, may switch the client to another group corresponding to the new statistics received from client as Group of Pictures resolution. The statistics may be, without limitation, a combination of blockiness level and packet loss level. The media bridge controller module can be configured to up-shift to a higher quality of the encoder group when the statistics factors are into higher ranges and the media controller defines the higher quality sustained according to a combination of factors. Furthermore, the media bridge controller can be configured to change a client from an encoder group to another according to the statistics received from said client to downshift to a lower quality encoder group.

In one embodiment of the invention the media bridge controller is configured to change a client from an encoder to another according to the statistics received from said client to up-shifting to a higher quality dynamically at Group Of Pictures resolution.

In one embodiment of the invention circuitry is provided in the system to carry out one or more of the following:
A) a video or an audio frame is split into new sub-frames replacing the initial one, using a wavelet 2D approach;
B) each sub-frame of a video or of an audio is encoded separately;
C) a new compressed raw data is created by joining each of the sub-frames encoded;
D) new compressed data is split into four compressed data;
E) each one of the four compressed data is decoded;
F) after decoding the video or the audio frame, the process is reversible; and
G) a filter provides the filter length correspond to a level of packet loss.

All the above and other characteristics and advantages of the invention will be further understood through the following illustrative and non-limitative description of preferred embodiments thereof, with reference to the appended drawings; wherein similar components are designated by the same reference numerals.

### BRIEF DESCRIPTION OF THE DRAWINGS

FIG. 1 schematically shows a global view of the casting of the audio and/or video stream;

FIG. 2 schematically shows a module including a video encoder and a streamer adaptive using real time adaptive reconfiguration;

FIG. 3 schematically shows the internal process of the statistical decision block;

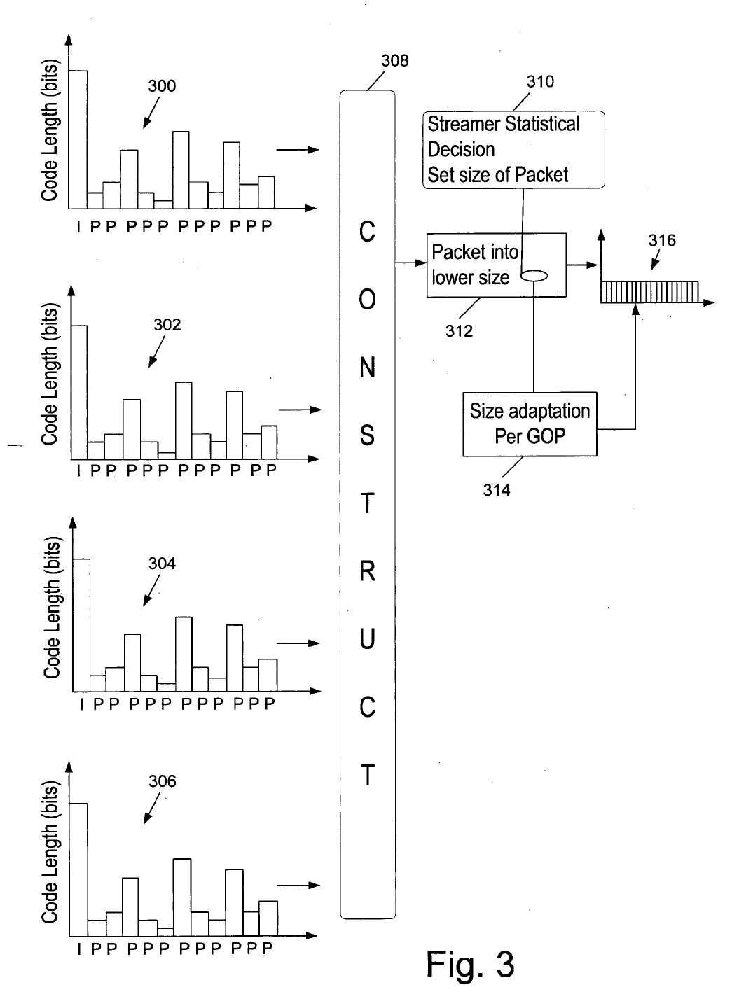

FIG. 4 schematically shows the internal process of the module dealing with the size adaptation per group of pictures;

FIG. 5 schematically shows the internal process of the module dealing with the statistical analysis and splitting to the corresponding group; and

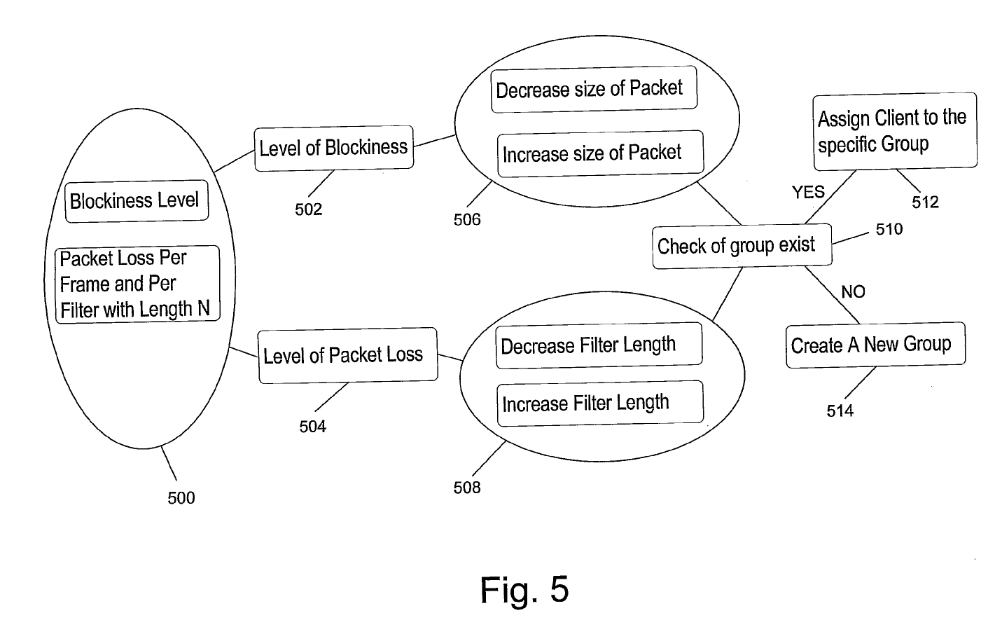

FIG. 6 schematically shows the internal process of the decoder player module.

### DETAILED DESCRIPTION OF PREFERRED EMBODIMENTS

According to an embodiment of the present invention, Simulcoding is performed by splitting the available bandwidth into sub-bandwidths; each encoder is responsible for a sub-bandwidth. As an example, an available bandwidth of 1 Mbit/s is divided into four bandwidths; the first encoder is responsible for the first sub-bandwidth {0 to 150 Kbit/s}, the second encoder is responsible for second sub-bandwidth {151 Kbit/s to 300 Kbit/s}, the third encoder is responsible for third sub-bandwidth {301 Kbit/s to 600 Kbit/s}, and the fourth encoder is responsible for the fourth sub-bandwidth {601 Kbit/s to 1000 Kbit/s}.

According to the previous example, each encoder makes an adaptive bit rate into the selected sub-bandwidth. For each selected sub-bandwidth the system chooses the adequate video codec and/or audio codec.

Adaptive Streaming is performed in two steps. In the first step the sub-band adapted to a client is selected and attached to said client. The second step is a continuous adaptive bit rate into the selected bandwidth.

According to an embodiment of the present invention a media bridge is constituted by a “statistic analyze and split to the corresponding group” block 108 and a “Multi Mux” block 110 which is a set of multiplexers. The number of multiplexers included in said set of multiplexers is equal to the number of available groups of encoders (104, 106).

Each multiplexer of a “Multi Mux” block 110 splits the video and/or the audio stream to all the clients attached to a same encoder group.

Each encoder continuously streams the video and/or the audio stream to the media bridge as a reflection of the produced stream. Said streams are not stored on standard HTTP Web servers, but the video is continuously streamed to standard servers running a media bridge (108, 110).

Each encoder can adaptively change the bit rate for a bandwidth range, because each encoder configuration is able to respond to a range of bandwidths.

For each bandwidth range, for example, the frame rate of the encoder can be configured, and the motion estimation parameter can be set. Any other configuration is possible.

Each encoder can be finely tuned to the best working case using the average feedback received by all clients attached to the same bandwidth range requirement. Accordingly, the encoder is set to a new bit rate in the specific bandwidth range.

According to an embodiment of the present invention, Adaptive Streaming works as described hereinbelow. When an Internet user requests a video and/or an audio stream, a request is sent to the media bridge, which creates a link between the user and one of the encoders in the group, attaching the user to the specific multiplexer splitting the corresponding group, the decision on which to select being made from statistics received at “statistical analyze” block 108. Media bridges can switch dynamically the link from an encoder to another, according to said statistics. The dynamical switch is done on the “Group Of Pictures” (GOP) resolution. It is possible to switch to one or multiple GOP frame. A second step of the process is the computation of the average of all the statistics attached to said group. Said average is sent to said group of encoders in order to update the encoder setting for the specific group.

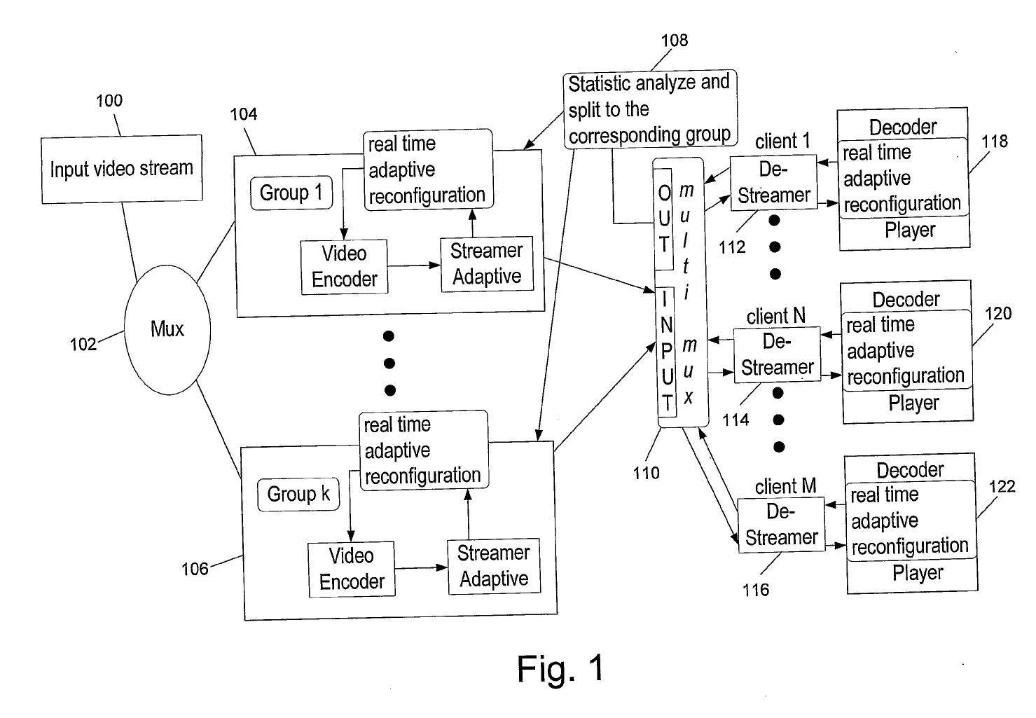

FIG. 1 describes a system according to another embodiment of the present invention, which allows a new way to optimize unicast and/or multicast transmissions over all types of digital channels. Said system is used as a statistical multiplexing and as broadcast transmission. It allows transmitting video and/or audio signals adapted to the transmission channel capacities.

According to still another embodiment of the present invention, the system is based on two main new approaches, namely “No More Buffering” (NMB) and “Dynamic Client/Server Reconfiguration” (DCSR). The NMB approach of the present invention prevents the need for buffering on the client side. A buffer use is hereby optional. The DCSR approach of the present invention allows adapting the streaming flow to the user bandwidth capacities in real time.

FIG. 1 schematically shows a global view of the system according to an embodiment of the present invention. Said system receives a video and/or an audio stream (100) from one source which can be compressed or uncompressed. If the input signal is compressed, the block 100 decompresses said input video and/or audio signal.

The output result of block 100 is sent to multiplexer 102. Multiplexer 102 sends the uncompressed signal simultaneously to encoders 104 and 106.

Each encoder is responsible for a number of clients having the same requirements. Each encoder deals with clients having the same properties, and needing the same bit rates range.

According to yet another embodiment of the present invention, using block 110, the Statistic Decision block 108 receives statistics from each user 112, 114, and 116 and decides with which encoder 104 or 106 said clients 112, 114, and 116 are associated.

Statistic Decision block 108 decides dynamically to switch the connection of a client managed by a first encoder to another encoder, which is more adequate to the requirements of said client.

According to still a further embodiment of the present invention, the video and/or audio stream packets sent to a client are destreamed and reordered, according to their initial arrangement (before network transmission), using a destreamer (112, 116) which is a device working like a streamer but inversely.

According to another embodiment of the present invention, when the video and/or the audio destreamed flow arrive to client, a client decoder (118,120) plays said video and/or said audio frame.

According to one embodiment of the present invention, a multiple frame is group into a number of frame, called Groups of Pictures (GOP). Said GOP are further subdivided in sequences of a pre-defined number of frames.

Typically, a Group of Pictures (GOP) comprises an “I frame” (which is an intra-coding frame) and a few number of “P frames” (which is a motion-based predictive coding frame) and potentially “B frames” (which is a motion-based bidirectional predictive coding frame). As an example, a GOP may comprise a set of frame defines such as “I, B, B, P, B, B, P, B, B, P, B, B, P, B, B” and sent with a frequency of 30 frames per second. The “I frame” is independently compressed. The number of said “I frame” generated packets is higher than the “P frames” or “B frames” which only encode changes from the previous frame.

Common parameters defining a GOP are the GOP length (the distance in frames from one I-frame to the next one) and the GOP structure (the arrangement of frames in said GOP).

According to still an embodiment of the present invention, Blockiness level is a perceptual measure of the block structure that is common to all discrete cosine transformation (DCT) based image compression techniques. The DCT is typically performed on N×M blocks. Blocks in the frame, and the coefficients in each block are quantized separately, leading to artificial horizontal and vertical borders between these blocks. Blockiness can also be generated by transmission errors, which often affect entire blocks in the video.

According to still another embodiment of the present invention the decoder (118, 120) send to the statistical analysis block 108 the “blockiness level” (as defined below) in the decode frame and the “degradation level” existing in the “Group Of Pictures”. The “degradation level” is the ratio between the number of packets emitted and the number of packets received; it corresponds to the loss of quality of the transmitted frame. This information allows the Statistic Decision block 108 to update the “packet size” and “RTP filter length” (which is the length of said packet) in order to optimize the encoder allocation to a client and more particularly the statistical multiplexing approach and the adaptive bandwidth decision. As a first advantage, said optimization overcomes the limitation of the transmission channel capacity for all the clients and the congestion problem for each client. As a second advantage, said optimization allows to use low bit rates and provides a better streaming quality.

“Blockiness” of the decoded frame is a scale from 1 to 5. Value 1 corresponds to a good quality of the video and/or the audio signals; value 3 defines a video and/or an audio quality with high blockiness but without deformation into the frame; value 5 defines that a part of the video and/or the audio frame is lost.

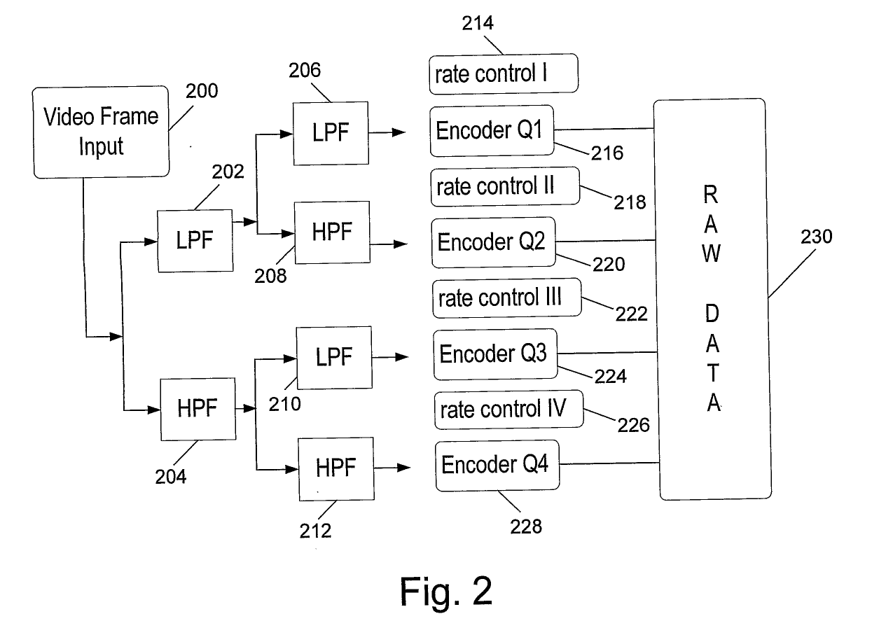

FIG. 2 shows in details an encoder block (104,106) according to yet another embodiment of the present invention. In said encoder, the input frame 200 is filtered in the horizontal direction by low pass filter 202 and high pass filter 204. The output block 202 is low pass filter 206 and high pass filter 208; the output block 204 is low pass filter 201 and high pass filter 212. The outputs of frames 206, 208, 210, and 212 are then sent to the encoders 216, 220, 224, and 228 respectively. Each encoder has its own rate control (respectively 214, 218, 222, and 226). As an example, the output of encoder Q1 216 generates a signal as shown on 300. In the same way, the encoder Q2 220 generates a signal as shown on 302, the encoder Q3 224 generates a signal as shown on 304, and the encoder Q4 228 generates a signal as shown on 306. Splitting into four-streams allows to perform the reduction of the size of each packet. The blocks 308 and 312 assemble the four streams 300, 302, 304, and 306 to create a new one. According to information received from the Statistic Decision of block 108 by the Streamer Statistical Decision block 310, the packet size unit is increased or decreased by changing the GOP resolution in 314.

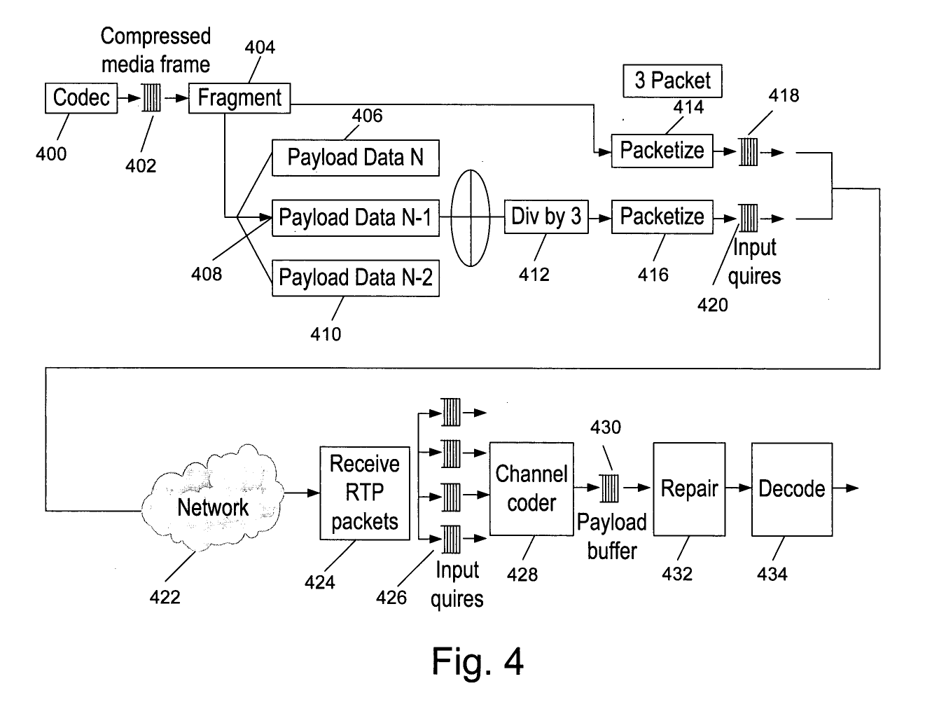

The “Packet into lower size” block 312 is explained using FIG. 4. According to yet a further embodiment of the present invention, Codec 400, the compressed media frame 402 and Fragment 404 summarize the previous steps of the process. A first packet is forwarded successively to 414, and to 416 by the way of 406; a second packet is forwarded too to 414, and to 416 by the way of 408; a next one is forwarded too to 414, and to 416 by the way of 410. Packets forwarded by the way of blocks 406, 408, and 410 are summed in order to generate an average of three consecutive packets. From the three initial packets the system generates four output packets which are respectively sent on a network 422 using the input queries 418 and 420.

From the “Div by 3” block 412 it is possible to modify the length of the filter. According to the quality of the transmission channel 110 defined by the “statistic decision” block 108, it is possible to adapt the size of the packets generated by the encoders. “Statistical decision” block 108 works using the level of blockiness defined between level 1 to level 5. When said blockiness is high, the size of the packets is reduced and vice versa.

Streaming (RTP) packets are received (108) and treated by the channel coder block 428 in order to evaluate the payload buffer 430. The payload buffer is used to repair the media 432 before decoding it (434).

According to an embodiment of the present invention, the system uses two parameters: the “Blockiness” and the “packets loss per frame and per filter with length N”, also previously called “degradation level”. These parameters are both used on the system 500.

The “packets loss per frame and per filter with length N”, previously called degradation level, is a ratio between the number of packets emitted and the number of packets received. If the “degradation level” is low it is necessary to decrease the size of the filter; if the “degradation level” is high it is necessary to increase the filter length. These parameters allow to define the level of Blockiness 502 and the level of packets lost 504. In view of these values, block 506 performs the decision of the new packet size and block 508 performs the decision about the filter length. Block 510 takes these two decisions and decides to which group to assign a client. Block 110 takes the stream from block 104 (or 106). In the other side block 110 forwards to the statistical decision block 108 all the information received from a client.

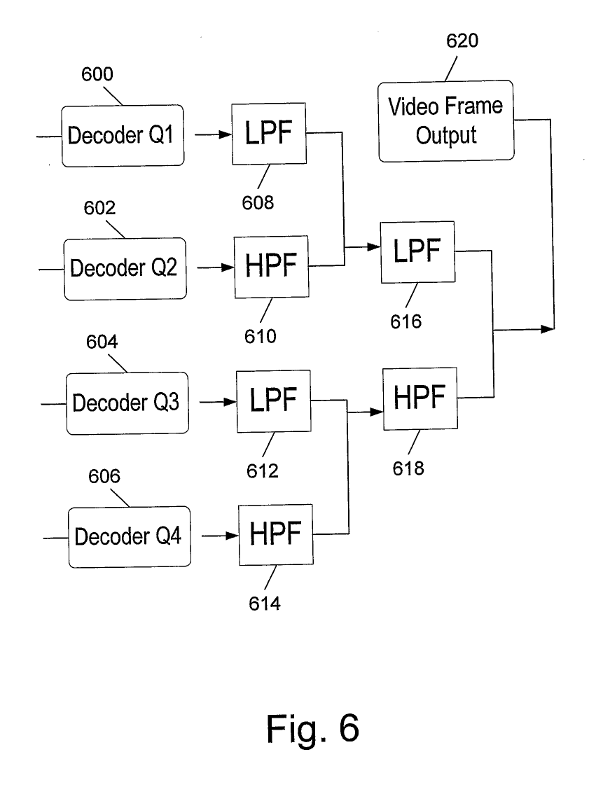

FIG. 6 schematically shows how the decoders 118, 120, and 122 work according to an embodiment of the present invention. After taking out redundant data and reordering the compressed stream packets (300, 302, 304 and 306) those are sent respectively to decoder Q1 600, decoder Q2 602, decoder Q3 604, and decoder Q4 606. Each decoder sends received data respectively to low pass filter 608, to high pass filter 610, to low pass filter 612, and to high pass filter 614. The results of low pass filter 608 and high pass filter 610 go to low pass filter 616 and the results of low pass filter 612 and high pass filter 614 go to low pass filter 618. The summation of low pass filter 616 and high pass filter 618 generates the decoded frame 620.

According to a further embodiment of the present invention uses a standard RTP protocol is used in order to avoid the need for a proprietary Streamer and De-streamer.

Although embodiments of the invention have been described by way of illustration, it will be understood that the invention may be carried out with many variations, modifications, and adaptations, without exceeding the scope of the claims.

1.-18. (canceled)

19. A method for carrying out video and/or audio adaptive-rate streaming, the method comprising:
providing a group of encoders, wherein each encoder is tuned to and responsible for a different sub-bandwidth within an available maximum bandwidth capacity,
selecting an encoder for each of one or more clients according to statistics representing one or more communication quality and visual video quality parameter,
each encoder encoding one or more video streams for its clients, and
forwarding data packets from each encoder to its client.

20. The method of claim 19, wherein each encoder deals with clients having the same properties and needing the same range of bit rates.

21. The method of claim 19, wherein said providing comprises choosing an appropriate video codec and/or audio codec for each sub-bandwidth.

22. The method of claim 19, wherein said providing comprises limiting each encoder to deliver a predefined range of bit rates defined for its sub-bandwidth.

23. The method of claim 19, wherein said statistics are a combination of at least
one of: “degradation level” and perceptual measure.

24. The method of claim 19, wherein the size of a sub-bandwidth is chosen according to the qualities of the encoder selected for said sub-bandwidth.

25. An apparatus for the video and audio adaptive-rate streaming, comprising:
a group of encoders, each of which is tuned to and responsible for a different sub-bandwidth within an available maximum bandwidth capacity,
wherein each of one or more clients is selectably connectable to one of said encoders according to statistics representing one or more of:
communication parameters and perceptual parameters,
each encoder to encode one or more video streams for its clients; and
a media bridge to decide with which encoder said clients are to be associated and to forward data packets from each encoder to its clients.

26. An apparatus according to claim 25, wherein said media bridge is configured to take an encoded stream of a Group of Pictures from each encoder and to forward said encoded stream to clients according to their statistics at every Group of Pictures.

27. An apparatus according to claim 25, wherein said media bridge comprises a unit to connect any client to a specific encoder depending on feedback statistics of a Group of Pictures sent by the client to the media bridge.

28. An apparatus according to claim 25, wherein said media bridge comprises a unit to generate an average performance factor for each encoder according to statistics received from said clients connected to said encoder.

29. An apparatus according to claim 28, wherein each encoder continuously adapts its bit rate according to said average performance factor.

30. An apparatus according to claim 25, wherein the media bridge comprises a unit to dynamically switch the connection of a client managed by a first encoder to another encoder according to client statistics.

31. An apparatus according to claim 25, wherein the media bridge comprises a unit to check that the statistics sent by the client match its encoder.

32. An apparatus according to claim 25, wherein said statistics are at Group of Pictures resolution.

33. An apparatus of claim 25, wherein the statistics are a combination of blockiness level and packet loss level.

34. A method for determining a degradation level of a transmission, the method comprising:
determining a ratio between the number of RTP packets emitted by an encoder and the number of packets received by each client;
if the degradation level is low, decreasing the length N of an RTP filter; and
if the degradation level is high, increasing the filter length N.

35. A method for encoding the video of each group, the method comprising:
splitting a video or an audio frame into sub-frames replacing said frame, using a 2D wavelet approach;
encoding each sub-frame of a video or of an audio separately;
creating a new compressed raw data by joining each of the encoded sub-frames;
splitting said new compressed data into four compressed data; and
encoding each one of the four compressed data.

36. A method for performing adaptive streaming, the method comprising:
dynamically attaching each client to an encoder operating within one sub-bandwidth; and
continuously adapting the bit rate of each encoder according to average statistics of all clients attached to said encoder.

37. A method for performing continuous bit rate adaptation of multiple clients, the method comprising:
determining the average statistics of said multiple clients having the same channel properties; and
continuously adapting a bit rate of an encoder encoding data from said multiple clients based on said average statistics.
